(19) United States
(12) Patent Application Publication
(10) Pub. No.: US 2018/0345537 A1
(43) Pub. Date: Dec. 6, 2018

(54) METHOD FOR MANUFACTURING A PATTERNED FLOOR COVERING AND PATTERNED FLOOR COVERING

(71) Applicant: NORA SYSTEMS GMBH, Weinheim (DE)

(72) Inventors: Mario KROEGER, Bruchsal (DE); Dieter RISCHER, Abtsteinach (DE)

(21) Appl. No.: 15/771,945

(22) PCT Filed: Oct. 30, 2015
(86) PCT No.: PCT/EP2016/074939

§ 371 Date: Apr. 27, 2018

(30) Foreign Application Priority Data
Oct. 30, 2015 (DE) 10 2015 118 618.7

(51) Int. Cl. B29B 9/06; B29C 43/24

(52) U.S. Cl. CPC B29B 9/06; B29L 2031/732; B29K 2995/002; B29C 43/24

(57) ABSTRACT

A method for manufacturing a patterned floor covering is disclosed. The method includes:
providing a first component a second component and a third component,
manufacturing an intermediate product by mixing the first component and the second component in a mixing device,
further processing the intermediate product into a web-shaped floor covering, the second intermediate product being reshaped.

The present disclosure further relates to a patterned floor covering obtainable by the method.

The present invention relates to a method for manufacturing a patterned floor covering. The invention further relates to a floor covering obtainable by this method.

DE 195 07 113 C1 discloses a method for manufacturing a moiré-patterned floor covering from rubber. This previously known method provides that the floor covering is constructed from two or three base colors. In this case, a short screw extruder is loaded with two or three differently colored strips of vulcanizable elastomeric material. The elastomeric material thereby is conveyed through the extruder without intermixing of the colors, extruded through a perforated disk, and broken off into shaped pieces of 1 to 2 mm each. Next, the shaped pieces are compressed into a material web in a two-roller calender and subsequently vulcanized.

EP 2 759 636 A2 discloses a marbled linoleum-based floor covering. During manufacture, initially linoleum granulates of different colors are manufactured. The granulates are impregnated with a thermoplastic binding agent and pressed so as to obtain a marbled floor covering.

DE 1 479 605 discloses a method for manufacturing marbled webs of thermoplastic plastics materials. In this case, differently colored plastics material mixtures are supplied to the upper and lower intake gap of a six-roller calender. Subsequently, the material passes through a further roller gap. As a result of the rollers damming up, the differently colored webs are mixed together.

It has been found that these previously known methods do not yet lead to an ideal visual appearance of the floor covering.

Therefore, an object of the invention is to specify a method which makes it possible to manufacture a durable patterned floor covering, and in particular a marbled floor covering which has a particularly appealing surface configuration. A further object of the invention is to specify a durable floor covering having a particularly appealing surface configuration.

The object of the invention is achieved through a method with the features of claim 1. Accordingly, the method for manufacturing a patterned floor covering comprises the following steps:
providing a first component and a second component, the first and second component being mixable and the first component having a first base color and the second component having a second base color;
manufacturing an intermediate product by mixing the first component and the second component in a mixing device, the mixing taking place in such a way that the intermediate product comprises first regions having the first base color, second regions having the second base color and third regions having a first mixed color;
further processing the intermediate product into a web-shaped floor covering.

This method makes it possible to manufacture a durable and wear-resistant floor covering which has a particularly appealing surface configuration. In particular, the method is suitable for manufacturing floor coverings having a marbled appearance or a moiré appearance. This is enhanced if the first and the second base color are different. In particular, the hue and/or brightness of the first and second base color may be different. In this case, a configuration can be achieved in which soiling and wear are only hardly visible. The mixing takes place in such a way that the components are not completely intermixed. Accordingly, the different color gradations of the different first and second base color are discernible on the finished floor covering. By contrast, a part of the components is intermixed in such a way that mixed colors also occur. By doing so, in spite of the use of a limited number of base colors in the floor covering, a number of regions having a fine color gradation occur. The method is particularly suitable for manufacturing elastomeric floor coverings.

It is advantageously provided that during the manufacture of the intermediate product, an amount A of the first component and an amount B of the second component are added, amount A making up between 50 vol % and 150 vol % of amount B. Preferably, amount A makes up between 80 vol % and 120 vol % of amount B. This enhances a visually appealing patterning of the floor covering, in particular finely gradated marbling.

A preferred embodiment of the invention provides that in the intermediate product the third regions having the first mixed color make up between 30 vol % and 50 vol %. This enhances a visually appealing patterning of the floor covering, in particular marbling.

An advantageous embodiment of the invention provides that the intermediate product is granulated in a granulator after the mixing. The granulated intermediate product is used during the further processing, in particular during the manufacture of the second intermediate product described below. This enhances a visually appealing patterning of the floor covering, in particular finely gradated marbling. As a result of using granulate, particularly finely gradated marbling can be obtained in particular. In addition, the granulate can be further processed easily or else temporarily stored. For manufacturing the granulate, the intermediate product may for example initially be extruded as strips, the strips being comminuted using blades and subsequently passed to a sieve. The mesh width of the sieve ensures that only granulate of the desired size can leave the sieve. Preferably, the average sieve diameter of the granulate is less than 10 mm. A further improvement provides that, during the manufacture of the second intermediate product described below, the intermediate product, as a granulate, and a third component, as a strip, are supplied to a second mixing device. These measures enhance a visually appealing patterning of the floor covering, in particular finely gradated marbling.

A particularly preferred embodiment of the invention provides that a third component is provided and that, during the further processing into a web-shaped floor covering, initially a second intermediate product is manufactured by mixing the intermediate product with the third component in a second mixing device, the second intermediate product comprising first regions having the first base color, second regions having the second base color, third regions having the first mixed color and fourth regions having a second mixed color. The second intermediate product can subsequently be further processed into the web-shaped floor covering. These measures enhance a visually appealing patterning of the floor covering, in particular finely gradated marbling. As a result of the multi-stage manufacture using the intermediate product and the second intermediate product, a floor covering can be obtained which also contains a plurality of mixed colors in a particularly fine distribution, as well as the base colors.

A particularly advantageous embodiment of the invention provides that the third component has a third base color. Preferably, the first base color is equal to the first base color in this case. This enhances an advantageous visual configuration. Particularly preferably, the third component may have the same composition as the first component.

An advantageous embodiment provides that, during the manufacture of the second intermediate product, an amount C of the third component is added together with an amount D of the intermediate product, amount C making up between 150 vol % and 250 vol % of amount D. Preferably, amount C makes up between 180 vol % and 220 vol % of amount D. This enhances a visually appealing patterning of the floor covering, in particular finely gradated marbling.

According to the invention, it is particularly preferred, in the second intermediate product, that the fourth regions having the second mixed color make up between 30 vol % and 70 vol %. This enhances a visually appealing patterning of the floor covering, in particular finely gradated marbling.

Preferably, in the second intermediate product, the first regions having the first base color make up between 20 vol % and 40 vol %. This enhances a visually appealing patterning of the floor covering, in particular finely gradated marbling.

It is advantageously provided that at least one further component having at least one further base color is provided, the further component being additionally added during the manufacture of the intermediate product and/or during the manufacture of the second intermediate product by mixing. In this way, regions having the further base color (or the further base colors) can be obtained in the intermediate product or the second intermediate product. Preferably, the further component is added during the manufacture of the intermediate product. In particular, the further base color is different from the first and second base color. This configuration enhances a further-improved visual configuration of the floor covering. In particular, particularly fine color gradations are made possible as a result, which make appealing marbling possible. According to the invention, it is preferred to provide a further component. With the first and second base color and the further base color, there are thus three base colors in total, which together with the mixed color or mixed colors enable a finely gradated configuration of the appearance, in particular fine marbling.

An advantageous embodiment of the invention provides that the second base color is darker than the first base color. Preferably, if a further component is used, the further base color is brighter than the first base color. This enhances an advantageous visual appearance of the floor covering and particularly enables gradated marbling.

A further improvement in the visual appearance is achieved if the color distance dE (Delta E) between the first base color and the second mixed color is between 1.0 and 5.0. The color distance dE is preferably between 1.4 and 3.0, and particularly preferably between 1.9 and 2.5. The color distance can be determined in accordance with the version of DIN 6176 valid at 1 Sep. 2015.

According to the invention, it is preferred for the first and the second component to be passed into the mixing device as strips. The optionally used further component(s) may also be passed into the mixing device as strips.

A particularly preferred embodiment of the invention provides that the mixing device and/or the second mixing device are formed as extruders. The extruders advantageously enable the desired partial intermixing, which enhances a visually appealing patterning of the floor covering, in particular finely gradated marbling. The mixing device and the second mixing device may be identical or different in this case. For discontinuous manufacture, the same device can be used once as a mixing device and once as a second mixing device. However, it is advantageous if the mixing device and the second mixing device are separate apparatuses.

Advantageously, the extruder is formed as a pin extruder. By using a pin extruder, it is possible to carry out the desired partial intermixing, which leads to finely gradated marbling. The pins of the pin extruder protrude into the annular space formed by the extruder screw, and result in the components being partially intermixed in the desired manner upon passing through the extruder. The extruder may in particular be formed as a short screw extruder and have a length/diameter ratio of between 4:1 and 10:1.

A further improvement is achieved if the second intermediate product is in the form of chips. Chips can be manufactured by breaking off downstream from the second mixing device. For this purpose, the second intermediate product can be extruded through a perforated disk and subsequently broken off at short intervals. This enhances a visually appealing patterning of the floor covering, in particular finely gradated marbling.

A preferred embodiment of the invention provides that the further processing into a web-shaped floor covering comprises calendering in a calendering system. This also enhances a visually appealing patterning of the floor covering, in particular finely gradated marbling. As a result of the calendering, deformation of the material, which enhances the marbling of the appearance, can be achieved. Preferably, this results in a directional orientation of the patterning. In addition, by means of the calendering, the (second) intermediate product can be reshaped efficiently while keeping the number of air bubbles small.

An advantageous embodiment of the invention provides that the calendering system comprises a pair of calender rollers having a first and a second calender roller, the first calender roller being moved at a first circumferential speed V1 and the second calender roller being moved at a second circumferential speed V2, and that the first circumferential speed V1 is more than 110% of the second circumferential speed V2. Preferably, the first circumferential speed V1 is more than 130% of the second circumferential speed V2. In this context, it is preferred for the first circumferential speed V1 to be less than 170% of the second circumferential speed V2. As a result of the different circumferential speeds of the rollers, the material can be deformed in the longitudinal direction. This enhances a visually appealing patterning of the floor covering, in particular finely gradated marbling. In particular, directionally orientated patterning can be achieved in this way.

A particularly preferred embodiment of the invention provides that the surface of the web-shaped floor covering is structured. The structuring may for example take place using a structured roller during the calendering. The structuring of the surface can further enhance the impression of a marbled surface.

According to the invention, it may be provided that the manufacture of the intermediate product and the second intermediate product are carried out at separate times. In this case, the intermediate product can be temporarily stored until the second intermediate product is being manufactured.

A preferred embodiment of the invention provides that the floor covering material comprises at least one elastomer and/or one thermoplastic elastomer. Preferably, the first, second and third component each comprise a cross-linkable elastomer and/or a thermoplastic elastomer. The optionally present further component (or further components) may also comprise a cross-linkable elastomer and/or a thermoplastic elastomer. By using an elastomer, particularly appealing patternings of the floor covering can be achieved. Furthermore, elastomeric floor coverings are particularly durable and wear-resistant. The elastomer is cross-linked after the second intermediate product has been reshaped into the web-shaped floor covering. The cross-linking may be carried out as vulcanization, for example on a continuous vulcanization system (AUMA), whilst supplying heat.

Advantageously, the elastomer comprises one or more substances selected from the group consisting of NR (natural rubber), BR (polybutadiene), SBR (styrene-butadiene rubber), NBR (acrylonitrile-butadiene rubber), EPM (ethylene-propylene rubber), EPDM (ethylene-propylene-diene rubber), IIR (butyl rubber), CR (chloroprene rubber), EVA (ethylene vinyl acetate) and IR (polyisoprene). SBR, NBR, NR and EPDM are particularly preferred, as well as mixtures thereof.

An advantageous embodiment provides that the first, second and third component, aside from optionally different colors, have the same composition. Preferably, the further component, aside from the color, also has the same composition.

Preferably, the web-shaped floor covering is cut to size. In this way, the floor covering may be manufactured as a rolled product or as floor covering tiles. According to the invention, it is preferred for the intermediate product and/or the second intermediate product to be manufactured whilst supplying heat. If components containing a cross-linkable elastomer are used, the temperature range preferred in this regard is between 60° C. and 100° C. By using this temperature range, a visually appealing patterning, in particular marbling, can be achieved.

Preferably, the first and second and the optionally used third and further component are plastically deformable.

The object of the invention is additionally achieved by a patterned floor covering manufactured by the method described hereafter.

Preferably, the floor covering has a marbled pattern on a visible surface, in particular the top face. The marbled pattern is formed by the first and second base color as well as by the first and second mixed color. If a further component is used, the marbled pattern is additionally formed by the further base color. This results in an appealing patterning having gradated marbling.

According to the invention, it is preferred for the web-shaped floor covering to be of a thickness between 1 mm and 10 mm. Particularly preferably, the thickness is between 1 mm and 5 mm.

The web-shaped floor covering may be formed single-layer or multi-layer. At least one layer is formed by the reshaped second intermediate product.

Further objects, features, advantages and possible application possibilities of the present invention may be derived from the following description of embodiments and from the drawings. All features described and/or depicted in the drawings, in their own right or in any reasonable combination, form the subject matter of the invention, also regardless of how they are combined in individual claims or the dependencies thereof

The drawings show:

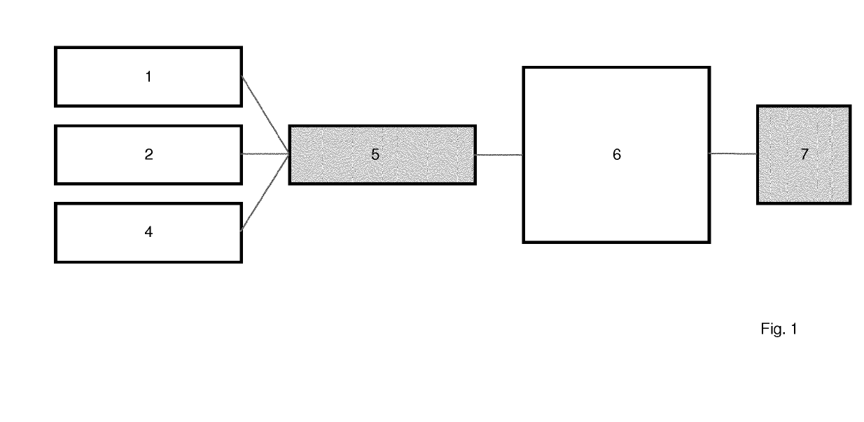

FIG. 1: a schematic representation of the first part of a method for manufacturing a patterned floor covering;

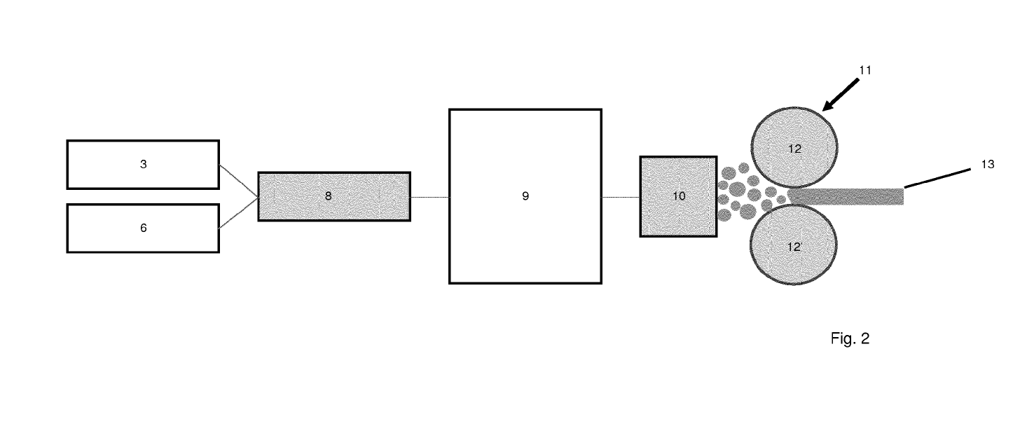

FIG. 2 the second part of the method for manufacturing a patterned floor covering.

FIG. 1 schematically shows the first part of the sequence of a method for manufacturing a patterned floor covering. A first component 1 and a second component 2 are provided. A third component 3, used in the second part of the method described in FIG. 2, is moreover provided. It can moreover be seen from FIG. 1 that in the embodiments shown a further component 4 is provided. The first, second, third and further component 1-4 are intermixable materials. The first component 1 has a first base color and the second component 2 has a second base color. The third component 3 has a third base color which is equal to the first base color. According to the invention, it is preferred if the base color of the component 3 but also the rest of its composition is equal to the first component 1. The further component 4 has a further base color. The first, second and further base color are each different. The shown exemplary embodiment provides that the second base color is darker than the first base color, whilst the further base color is brighter than the first base color.

Since the components are intermixable, a mixed color can be obtained when the components are mixed.

The components each contain a cross-linkable elastomer. These are in particular elastomer compounds.

The exemplary embodiment provides that during the manufacture of the intermediate product, an amount A of the first component, an amount B of the second component and an amount E of the further component are added. In the exemplary embodiment shown, amount A makes up between 80 vol % and 120 vol % of amount B. In particular, it may be provided that amounts A, B and E are equally large and therefore the first, second and further component 1, 2, 4 are fed into the mixing device 5 in equal proportions.

The first, second and further component 1, 2, 4 are provided in the form of strips and supplied to the mixing device 5 in this form. In the mixing device 5, the components are mixed to form the intermediate product 6. The mixing takes place in such a way that, in the intermediate product 6, first regions having the first base color, second regions having the second base color, third regions having a first mixed color and fourth regions having the further base color are obtained. As a result of respective adjustment of the mixing device, it can be achieved that, in the intermediate product 6, the third regions having the first mixed color make up between 30 and 50 vol %. For example, the first mixed color may make up 40 vol % of the intermediate product 6. In the exemplary embodiment, the first region, the second region and the fourth region may each make up 20 vol % of the intermediate product 6.

The intermediate product 6 may for example be released from the mixing device 5 as a strip. The strip may be comminuted in a granulator 7. The granulator 7 may in particular comprise blades for comminuting the strips, and a sieve. By using a sieve, it is achieved that the diameter of the granulates thus produced is less than the mesh width of the sieve.

FIG. 2 shows the second part of the method for producing the patterned floor covering. This second part can be carried out immediately after the manufacture of the intermediate product. However, it is also possible to store the intermediate product and to proceed with manufacturing the second intermediate product at a later time.

It can be seen from FIG. 2 that the second mixing device 8 is loaded with the third component 3 and the intermediate product 6. During the manufacture of the second intermediate product, an amount C of the third component 3 is fed into the second mixing device 8 together with an amount D of the intermediate product. In the exemplary embodiment, amount C makes up between 150 vol % and 250 vol % of amount D. For example, amount C may make up 200% of amount D. Preferably, the third component 3 is fed into the second mixing device 8 as a strip and the intermediate product 6 is fed into as a granulate.

In the second mixing device 8, mixing takes place again so as to produce the second intermediate product 9. The second mixing device 8 is set up in such a way that the second intermediate product 9 has first regions having the first base color, second regions having the second base color, third regions having the first mixed color and fourth regions having the second mixed color. Moreover, in the exemplary embodiment shown, the second intermediate product also has fifth regions having the further base color. For example, in the second intermediate product, the regions having the second mixed color may make up between 30 vol % and 70 vol %, for example 50 vol %. In this case, in the second product, the first regions having the first base color may make up between 20 vol % and 40 vol %, for example 30 vol %. The remaining regions of the second intermediate product are divided up between the second base color, the further base color and the first mixed color. For example, the regions having the second and the further base color may each make up 5% and the region having the first mixed color may make up 10%.

By releasing the second intermediate product from the second mixing device 8 through, for example, a perforated disk and breaking up the emerging mass at short intervals, chips can be manufactured from the second intermediate product.

The second intermediate product 9 is subsequently further processed into a web-shaped floor covering 13. In this context, the second intermediate product 9 is reshaped. In the shown exemplary embodiment, the second intermediate product 9 is comminuted into chips in a comminution device 10. The comminution device 10 may for example comprise a cutting blade. The chips of the second intermediate product are subsequently reshaped by calendering in a calendering system 11. The calendering system 11 comprises a pair of calender rollers comprising a first calender roller 12 and a second calender roller 12′. The calender rollers 12, 12′ compress the second intermediate product 9 and shape it into a web 13. Optionally, for manufacturing the web, a plurality of calender rollers arranged in succession may be provided. In the exemplary embodiment shown, the second intermediate product 9 is processed in the calendering system 11 after the mixing. However, it is also possible to store the second intermediate product 9 temporarily and to process it further at a later time.

In the described exemplary embodiment, this results in a web which contains cross-linkable elastomer. By cross-linking the cross-linkable elastomer, a durable floor covering can be obtained. The cross-linking may for example take place in a vulcanization system (for example AUMA) whilst supplying heat and pressure.

In the shown exemplary embodiment, the first calender roller 12 is moved at a first circumferential speed V1 and the second calender roller 12′ is moved in the opposite direction at a second circumferential speed V2. The circumferential speed V1 is higher than the circumferential speed V2. As a result of the different circumferential speeds of the rollers 12, 12′, the material is deformed in the longitudinal direction. In this way, the regions of different colors contained in the second intermediate product 9 can be distorted in such a way that particularly finely gradated marbling occurs.

The mixing device and the second mixing device may each be formed as an extruder. In particular so-called pin extruders are suitable. By using pins, the degree of intermixing of the material when passing through the mixing devices in the form of extruders 5, 8 can be controlled. In this way, the desired visual appearance of the patterned floor covering can be obtained.

1. A method for manufacturing a patterned floor covering, comprising the following steps:
providing a first component and a second component, the first and second component being mixable and the first component having a first base color and the second component having a second base color;
manufacturing an intermediate product by mixing the first component and the second component in a mixing device, the mixing taking place in such a way that the intermediate product comprises first regions having the first base color, second regions having the second base color and third regions having a first mixed color;
further processing the intermediate product into a web-shaped floor covering.

2. The method according to claim 1, wherein during the manufacture of the intermediate product, an amount A of the first component and an amount B of the second component are fed into the mixing device, amount A making up between 50 vol % and 150 vol % of amount B.

3. The method according to claim 1, wherein in the intermediate product, the third regions having the first mixed color make up between 30 vol % and 50 vol %.

4. The method according to claim 1, wherein the intermediate product is granulated in a granulator after the mixing.

5. The method according to claim 1, wherein a third component is provided and that, during the further processing into a web-shaped floor covering, a second intermediate product is manufactured by mixing the intermediate product with the third component in a second mixing device, the second intermediate product comprising first regions having the first base color, second regions having the second base color, third regions having the first mixed color and fourth regions having a second mixed color.

6. The method according to claim 5, wherein the color distance dE between the first base color and the second mixed color as determined in accordance with DIN 6176 is between 1.0 and 5.0.

7. The method according to claim 5, wherein the third component has a third base color.

8. The method according to claim 5, wherein during the manufacture of the second intermediate product, an amount C of the third component and an amount D of the intermediate product are added, amount C making up between 150 vol % and 250 vol % of amount D.

9. The method according to claim 5, wherein in the second intermediate product, the fourth regions having the second mixed color make up between 30 vol % and 70 vol %.

10. The method according to claim 5, wherein in the second intermediate product, the first regions having the first base color make up between 20 vol % and 40 vol %.

11. The method according to claim 1, wherein at least one further component having at least one further base color is provided, the further component being additionally fed to the mixing device or to the second mixing device during the manufacture of the intermediate product and/or during the manufacture of the second intermediate product.

12. The method according to claim 1, wherein the mixing device and/or the second mixing device are extruders.

13. The method according to claim 1, wherein the further processing into a web-shaped floor covering comprises calendering in a calendering system.

14. The method according to claim 1, wherein the calendering system (11) comprises a pair of calender rollers having a first and a second calender roller, the first calender roller being moved at a first circumferential speed V1 and the second calender roller being moved at a second circumferential speed V2, and in that the first circumferential speed V1 is more than 110% of the second circumferential speed V2.

15. A patterned floor covering obtainable by a method according to claim 1.

16. A patterned floor covering according to claim 15, wherein the floor covering has a marbled pattern on a visible surface.
